(19) United States
(12) Patent Application Publication
(10) Pub. No.: US 2011/0160355 A1
(43) Pub. Date: Jun. 30, 2011

(54) ASPHALT ADDITIVE WITH IMPROVED PERFORMANCE

(76) Inventor: Jean-Valery Martin, Princeton, NJ (US)

(21) Appl. No.: 12/940,571

(22) Filed: Nov. 5, 2010

Related U.S. Application Data
(60) Provisional application No. 61/258,927, filed on Nov. 6, 2009.

(51) Int. Cl. C08L 95/00

(52) U.S. Cl. 524/68

(57) ABSTRACT

The present invention relates to a modified asphalt binder composition comprising:
a. 70-85% by weight asphalt binder
b. 0.1-5% by weight PPA
c. 0.5-30% by weight supramolecular rubber.

This application claims benefit of U.S. provisional patent application Ser. No. 61/258,927 filed Nov. 6, 2009.

### BACKGROUND OF THE INVENTION

A. Field of the Invention

The present invention is generally directed to asphalt additives for improved performance and the use of the asphalt additives. In particular, the invention is directed to a modified asphalt binder composition comprising a supramolecular rubber additive.

B. Description of the Related Art

Modified asphalt binder compositions are known to those ordinarily skilled in the art. Various asphalt additives have been used to improve the performance of asphalt in use under a wide range of environmental conditions. One asphalt additive that has been used is polyphosphoric acid (PPA), alone or in combination with other additives. Asphalt additives also include polymers such as block copolymers of styrene and butadiene. See, U.S. Pat. No. 5,880,185; U.S. Pat. No. 6,011,095, U.S. Pat. No. 5,618,862, and US 2006/0089429. Ground tire rubber, also known as crumb rubber, can also be added to asphalt compositions.

Now, Applicants have discovered a modified asphalt binder composition comprising a supramolecular rubber. The composition of the present invention is useful under a wide spectrum of road paving conditions. The composition of the present invention is also useful in roofing and industrial asphalt applications.

### SUMMARY OF THE INVENTION

The present invention relates to a modified asphalt binder composition comprising:
a. 70-85% by weight asphalt binder
b. 0.1-5% by weight PPA
c. 0.5-30% by weight supramolecular rubber.

The present invention further relates to a modified asphalt binder composition comprising:
a. 70-85% by weight asphalt binder
b. 0.1-5% by weight PPA
c. 0.5-30% by weight supramolecular rubber.
d. 0.1-15% by weight of a polymer

### DEFINITIONS AND USAGES OF TERMS

The term “asphalt binder”, as used herein, means a black or brown petroleum-like material that has a consistency varying from viscous liquid to glassy solid. It is obtained either as a residue from the distillation of petroleum or from natural deposits; and it contains compounds of hydrogen and carbon with minor proportions of nitrogen, sulfur, and oxygen.

The terms “flux” and “slop”, as used herein, mean the material at the bottom of the vacuum tower of crude distillation. Flux or slop may be added to the asphalt binder to obtain a softer asphalt for use in colder climates.

### DETAILED DESCRIPTION OF THE INVENTION

The present invention relates to a modified asphalt binder composition comprising :
a. 70-85% by weight asphalt binder
b. 0.1-5% by weight PPA
c. 0.5-30% by weight supramolecular rubber.

The present invention further relates to a modified asphalt binder composition comprising:
a. 70-85% by weight asphalt binder
b. 0.1-5% by weight PPA
c. 0.5-30% by weight supramolecular rubber.
d. 0.5-15% by weight of a polymer

The present invention is directed to the modification of asphalt binder using PPA in combination with a class of polymers generally referred to as supramolecular rubber. The supramolecular rubber is a polymer in the family described by Cordier and Montarnal. This family of polymers exhibits self-healing and thermoreversible properties that can provide desirable physical attributes in a modified asphalt binder. See, Cordier, et al., “Self-healing and thermoreversible rubber from supramolecular assembly”, Nature, February 2008 (copy attached) and Montarnal et al., “Synthesis of Self-Healing Supramolecular Rubbers from Fatty Acid Derivatives, Diethylene Triamine, an Urea”, Journal of Polymer Science :Part A: Polymer Chemistry, 2006 (copy attached), the entire contents of each of which are hereby incorporated by reference. Supramolecular rubbers are also disclosed in US 2009/0062551, incorporated by reference herein.

The modified asphalt binder composition of the present invention is comprised of asphalt binder, PPA and a supramolecular rubber. A cross-linking agent may also be added to the asphalt, but is not required. Other polymers, in addition to the supramolecular rubber, may optionally be added to the asphalt binder composition. Not wishing to be bound by theory, the use of PPA in conjunction with the supramolecular rubber is thought to reduce the compaction temperature of the asphalt binder and result in better workability than inclusion of the supramolecular rubber alone.

The asphalt binder may be combined with aggregate for use as an asphalt pavement. The asphalt binder may also be used for any other purpose for which an asphalt binder is typically used. For example, the asphalt binder may be used in roofing shingles or in roofing membranes.

The ummodified asphalt binder may be any type of asphalt. Particularly preferred asphalts are very PPA reactive asphalt types. The asphalt binder may also be combined with flux or slop.

The PPA useful in the present invention is comprised of orthophosphoric and polyphosphoric acids at concentrations ranging from 50-120% (orthophosphoric acid weight basis). The PPA is preferably polyphosphoric acid having a H₃PO₄ equivalent weight concentration between 105% and 118%. The invention is not limited in this regard, and any PPA formulation may be used.

The modified asphalt binder composition preferably comprises between about 70% and about 98.5% by weight asphalt binder, between about 0.1% and about 5% by weight PPA, and between about 0.5% and about 30% by weight of the supramolecular rubber polymer. In another embodiment of the invention, the level of PPA is between about 0.5-1.5% by weight. In yet another embodiment, the level of supramolecular rubber is 1.0-5.0% by weight.

In embodiments of the modified asphalt binder composition, using cross-linking agents or additional polymers discussed herein below, the amount of asphalt binder may be reduced to less than 70% by weight depending upon the quantities of the cross linking agents or additional polymers used.

Optionally, the composition may include a cross-linking agent. Any cross-linking agent known to those skilled in the art may be used. When a cross-linking agent is used, the cross-linking agent will preferably comprise between about 0.05% and about 3% of the modified asphalt composition. Crosslinking agents useful in the practice of the present invention include, but are not limited to, sulfur donor coupling agents as disclosed in U.S. Pat. No. 5,618,862; U.S. Pat. No. 5, 880,185; U.S. Pat. No. 6,011,095 and US 2006/0089429.

If desired, one or more polymers in addition to the supramolecular rubber may be added to the modified asphalt binder. Any polymer known to those skilled in the art for use in producing modified asphalt may be used. For example, crumb rubber, such as ground tire rubber, may also be added to the modified asphalt composition. Where an additional polymer is added to the modified asphalt mixture, the additional polymer will preferably comprise between about 0.1% and about 15% of the modified asphalt.

Examples of polymers that may be added to the modified asphalt binder composition are disclosed in, for example, U.S. Pat. No. 5,880,185; U.S. Pat. No. 6,011,095; U.S. Pat. No. 6,031,029 and U.S. Pat. No. 6,228,909.

The modified asphalt binder of the present invention is produced by heating the asphalt binder, while mixing, to a temperature of between about 210° F. and about 550° F. The PPA, supramolecular rubber and any optional additives are added to the heated asphalt binder, also while mixing. The PPA and supramolecular rubber may be added separately in any order, or they may be pre-mixed and added to the asphalt binder together.

If a cross-linking agent is used, it may be added to the asphalt binder before or after the PPA or the supramolecular rubber, or it may be combined with the PPA and/or the supramolecular rubber prior to addition to the asphalt binder. Similarly, if additional polymers are added, they may be added to the asphalt binder before or after the PPA or the supramolecular rubber, or the polymers may be combined with the PPA and/or the supramolecular rubber prior to addition to the asphalt binder. In addition, the additional polymers may be added before, after or at the same time as the crosslinking agents.

In use, the modified asphalt binder can be combined with aggregate using either a hot mix process or a warm mix process. The modified asphalt binder provides improved workability and ease of compacting in pavement applications.

We claim:

1. A modified asphalt binder composition comprising:
a. 70-85% by weight asphalt binder
b. 0.1-5% by weight PPA
c. 0.5-30% by weight supramolecular rubber.

2. A modified asphalt binder composition comprising:
a. 70-85% by weight asphalt binder
b. 0.1-5% by weight PPA
c. 0.5-30% by weight supramolecular rubber
d. 0.1-15% by weight of a polymer

3. A modified asphalt binder composition comprising:
a. 70-85% by weight asphalt binder
b. 0.5-1.5% by weight PPA
c. 1.0-5.0% by weight supramolecular rubber

4. A modified asphalt binder composition comprising:
a. 70-85% by weight asphalt binder
b. 0.5-1.5% by weight PPA
c. 1.0-5.0% by weight supramolecular rubber
d. 0.1-15% by weight of a polymer
